(19) United States
(12) Patent Application Publication
(10) Pub. No.: US 2017/0119036 A1
(43) Pub. Date: May 4, 2017

(54) HAND HOLDABLE EDIBLE DAIRY COMPOSITION

(71) Applicant: General Mills, Inc., Minneapolis, MN (US)

(72) Inventor: Ronald M Girard, Buffalo, MN (US)

(73) Assignee: General Mills, Inc., Minneapolis, MN (US)

(21) Appl. No.: 15/129,465

(22) PCT Filed: Mar. 27, 2014
(86) PCT No.: PCT/US14/31937

§ 371 Date: Sep. 27, 2016

(51) Int. Cl. A23L 29/281; A23C 9/18; A23C 9/133

(52) U.S. Cl. CPC A23L 29/281; A23C 9/133; A23C 9/18

(57) ABSTRACT

A hand holdable edible composition including a dairy ingredient and gelatin is described. A method for making a hand holdable edible composition including a dairy ingredient and gelatin is also described.

### BACKGROUND

As individuals find their time occupied by an increasing number of activities, it has become more important for those individuals to have access to convenient foods. Convenient foods are packaged in forms and packages that make it easier to consume such foods on-the-go. As consumers become more aware of the need for more nutritional foods, particularly foods that encourage children to have a healthier diet, while still requiring convenience, a new challenge has been to produce foods that fulfill both needs while still providing an enjoyable eating experience.

### SUMMARY

The present disclosure relates to a hand holdable edible composition including a dairy ingredient and gelatin. Such a hand holdable edible composition be conveniently packaged and provide benefits of a dairy ingredient (e.g., a fermented dairy ingredient) and/or a live and active culture.

In one embodiment, a hand holdable edible composition includes a dairy ingredient, a live and active culture, and gelatin in an amount of from about 4% to about 50% by weight of the hand holdable edible composition. The hand holdable edible composition can be formed as a sheet having a thickness of from about 1 mm to about 5 mm.

The sheet can be layered on a support material. The sheet and support material can be rolled into a scroll-like configuration.

The dairy ingredient can be a fermented dairy ingredient.

The hand holdable edible composition can further include a fruit or vegetable puree, a flavoring agent, and/or a coloring agent.

In another embodiment, a hand holdable edible composition includes a fermented dairy ingredient and gelatin in an amount of from about 4% to about 50% by weight of the hand holdable edible composition. The hand holdable edible composition can be formed as a sheet having a thickness of from about 1 mm to about 5 mm.

The sheet can be layered on a support material. The sheet and support material can be rolled into a scroll-like configuration.

The hand holdable edible composition can further include a fruit or vegetable puree, a flavoring agent, and/or a coloring agent.

A method for making a hand holdable edible composition is also provided herein. The method includes combining a gelatin solution with a dairy ingredient to obtain a fluid dairy composition having a temperature of from about 70° F. to about 120° F. and a gelatin concentration of from about 4% to about 50% by weight of the fluid dairy composition, agitating the fluid dairy composition, passing the fluid dairy composition between a first roller and a second roller to form a sheeted dairy composition having a thickness of from about 1 mm to about 5 mm, depositing the sheeted dairy composition onto a support material, and cooling the sheeted dairy composition to obtain the hand holdable edible composition.

The dairy ingredient can be a fermented dairy ingredient. The fermented dairy ingredient can include a live and active culture. The live and active culture can be included in the hand holdable edible composition.

The method can further include adding a live and active culture to the dairy ingredient, the gelatin solution, or the fluid dairy composition. The live and active culture added to the dairy ingredient, the gelatin solution, or the fluid dairy composition can be present in the hand holdable edible composition.

The first roller and second roller can have a temperature of from about 45° F. to about 80° F.

The method can further include rolling the hand holdable composition into a scroll-like configuration.

The hand holdable composition can be produced as a continuous sheet. The continuous sheet can be cut into a plurality of smaller sheets.

The method can further include adding particulates, a fruit or vegetable puree, a flavoring agent, or a coloring agent to the gelatin solution, the dairy ingredient, or the fluid dairy composition.

The gelatin solution can be pasteurized.

These and various other features and advantages will be apparent from a reading of the following detailed description.

### DETAILED DESCRIPTION

The present disclosure relates to a hand holdable edible composition including dairy ingredient and gelatin. A hand holdable edible composition provided herein has a benefit of providing a dairy ingredient in a format that can be both portable and provide an enjoyable eating experience.

Ingredients derived from milk (i.e., dairy ingredients) can provide at least some of the nutritional benefits of milk, such as providing a dietary source of calcium, protein, and vitamins. Suitable dairy ingredients include non-fermented dairy ingredients and fermented dairy ingredients. Examples of a dairy ingredient suitable for use in a hand holdable edible composition include milk, pudding, yogurt, kefir, fresh cheese, clabber, and the like.

A dairy ingredient suitable for use in the composition and methods provided herein can be produced using any appropriate method. For example, yogurt can be produced by fermenting a dairy base, such as those described in, e.g., U.S. Pat. No. 4,971,810, U.S. Pat. No. 5,820,903, U.S. Pat. No. 6,235,320, U.S. Pat. No. 6,399,122, and U.S. Pat. No. 6,740,344. Organisms suitable for fermenting a dairy base to produce a yogurt include lactic acid producing bacteria, such as, for example, Lactobacillus species (e.g., Lactobacillus delbrueckii sub sp. bulgaricus, Lactobacillus lactis, Lactobacillus acidophilus), Lactococcus species (e.g., Lactococcus lactis, Lactococcus lactis subsp. lactis biovar. diacetyllactis, Lactococcus lactis subsp. cremoris), Streptococcus species (e.g., Streptococcus thermophilus, Streptococcus salivarius sub sp. thermophilus, Streptococcus lactis var. bollandicus, Streptococcus taette), Bifidobacterium species (e.g., Bifidobacterium lactis), and the like, and combinations thereof.

A dairy ingredient can be included in a hand holdable edible composition provided herein in an amount of about 2% to about 96% by weight of the hand holdable edible composition. For example, hand holdable edible composition can contain a dairy ingredient in an amount of from about 2% to about 50%, about 5% to about 80%, about 5% to about 95%, about 10% to about 60%, about 10% to about 75%, about 20% to about 40%, about 20% to about 65%, about 30% to about 45%, about 40% to about 50%, about 40% to about 70%, about 50% to about 80%, about 70% to about 95%, and the like, based on the weight of the hand holdable edible composition.

In some embodiments, a dairy ingredient can be included in a hand holdable edible composition in order to achieve a desired amount of a nutrient (e.g., protein, calcium, vitamin D, and the like) per serving of the hand holdable edible composition. For example, the amount of a dairy ingredient included in a hand holdable edible composition can be adjusted to achieve a protein content of about 2 grams to about 16 grams (e.g., about 2 g to about 5 g, about 2 g to about 6 g, about 6 g to about 8 g, about 6 g to about 10 g, about 7 g to about 12 g, about 8 g to about 10 g, about 8 g to about 16 g, about 9 g to about 14 g, about 10 g to about 12 g, about 10 g to about 15 g, about 6 g, about 7 g, about 8 g, about 9 g, about 10 g, about 12 g, and the like) per serving of the hand holdable edible composition. In another example, the amount of a dairy ingredient included in hand holdable edible composition can be adjusted to achieve a calcium content of 50 mg to about 300 mg (e.g., about 50 mg to about 75 mg, about 50 mg to about 120 mg, about 75 mg to about 100 mg, about 75 mg to about 150 mg, about 100 mg to about 180 mg, about 100 mg to about 200 mg, about 120 mg to about 250 mg, about 150 mg to about 300 mg, and the like) per serving of the hand holdable edible composition.

A dairy ingredient suitable for use in a hand holdable edible composition can include one or more additives to modify process and/or product characteristics. Examples of such additives include, without limitation, flavoring agents, coloring agents, acidulants, process viscosity modifiers, sweeteners, sequestrants, preservatives, emulsifiers, vitamins and/or minerals, and the like.

A live and active culture can also be included in a hand holdable edible composition. A live and active culture can provide one or more benefit (e.g., digestive benefits and/or immune benefits) when consumed as part of an individual's diet. A live and active culture can be included in a hand holdable edible composition as a part of a dairy ingredient (e.g., a yogurt), or a live and active culture can be added at one or more steps in a method for making a hand holdable edible composition, as provided herein. A live and active culture can include one or more lactic acid producing bacteria (e.g., Lactobacillus delbrueckii subsp. bulgaricus and/or Streptococcus thermophiles).

A hand holdable edible composition can include a live and active culture in an amount to provide at least about 1×10⁶ colony forming units (CFU) (e.g., at least about 5×10⁶ CFU, at least about 1×10⁷ CFU, at least about 5×10⁷ CFU, at least about 1×10⁸ CFU, at least about 5×10⁸ CFU, at least about 1×10⁹ CFU, at least about 5×10⁹ CFU, at least about 1×10¹⁰ CFU) of lactic acid producing bacteria per gram of the hand holdable edible composition at the time of production of the composition. CFU count can be measured from a sample of a hand holdable edible composition obtained within 6 hours following packaging the hand holdable edible composition and tested using the protocol described by the International Organization for Standardization in ISO 7889:2003 (IDF 117: 2003) Yogurt—Enumeration of characteristic microorganisms—Colony-count technique at 37 degrees C.

A hand holdable edible composition further includes gelatin. Gelatin is a hydrocolloid that can provide various benefits when consumed, including increasing bone, hair, and nail strength, and alleviating arthritis symptoms. In addition, gelatin provides structural support for a hand holdable edible composition. A gelatin suitable for use in a hand holdable edible composition can have a Bloom Strength number of from about 150 to about 250 grams (e.g., from about 150 to about 200, from about 180 to about 250, from about 230 to about 250, and the like). A gelatin with a higher Bloom Strength number can be used to increase the stiffness of a hand holdable edible composition as compared to a gelatin with a lower Bloom Strength number.

Gelatin is included in a hand holdable edible composition in an amount of from about 4% to about 50% (e.g., from about 4% to about 10%, from about 4% to about 15%, from about 4% to about 25%, from about 4% to about 40%, from about 5% to about 15%, from about 5% to about 30%, from about 6% to about 20%, from about 8% to about 12%, from about 10% to about 25%, from about 15% to about 40%, from about 20% to about 50%, and the like) by weight of the a hand holdable edible composition. In some embodiments, the amount of gelatin can be adjusted based on the desired handleability or stiffness of the hand holdable edible composition in which it's included. For example, if a greater stiffness is desired, a larger amount of gelatin can be included as compared the amount of gelatin in a softer hand holdable edible composition.

In some embodiments, a hand holdable edible composition can include a fruit and/or vegetable puree. A fruit and/or vegetable puree can be added in an amount of from about 1% to about 50% (e.g., from about 1% to about 5%, from about 1% to about 8%, from about 2% to about 8%, from about 2% to about 15%, from about 5% to about 10%, from about 5% to about 15%, from about 8% to about 12%, from about 8% to about 20%, from about 10% to about 15%, from about 15% to about 20%, about 20% to about 30%, about 25% to about 45%, and the like) by weight of a hand holdable edible composition. In some embodiments, a fruit and/or vegetable puree can be added in an amount sufficient to provide a desired color, flavor, texture, and/or nutritional profile in a hand holdable edible composition.

In some embodiments, a hand holdable edible composition can include an edible particulate, such as, for example, nut particulates (e.g., peanuts, walnuts, cashews, almonds, and the like), seed particulates (e.g., sunflower seed, chia seeds, pumpkin seeds, and the like), confections (e.g., chocolate, candy, and the like), or other edible particulate. A particulate can be added in an amount of from about 1% to about 20% (e.g., from about 1% to about 5%, from about 1% to about 8%, from about 2% to about 8%, from about 2% to about 15%, from about 5% to about 10%, from about 5% to about 15%, from about 8% to about 12%, from about 8% to about 20%, from about 10% to about 15%, from about 15% to about 20%, and the like) by weight of a hand holdable edible composition. In some embodiments, a particulate can be added in an amount sufficient to provide a desired color, flavor, texture, and/or nutritional profile in a hand holdable edible composition.

In some embodiments, a hand holdable edible composition provided herein can contain additional ingredients that contribute to the nutritional profile, flavor, texture, or other characteristics of the hand holdable edible composition. For example, a hand holdable edible composition can contain an ingredient that enhances the nutritional profile of the hand holdable edible composition, such as, without limitation, one or more vitamin (e.g., vitamin A, vitamin C, thiamin, vitamin D, riboflavin, niacin, vitamin B6, folic acid, vitamin B12, or the like), one or more mineral (e.g., calcium, iron, phosphorus, zinc, or the like), and/or one or more fat (e.g., a grain oil, a vegetable oil, or the like).

In some embodiments, a hand holdable edible composition can include no additional flavoring. In some embodiments, a hand holdable edible composition provided herein can be flavored (e.g., sweet or savory). In some embodiments, a hand holdable edible composition provided herein can contain one or more flavoring agent and/or coloring agent. A flavoring agent suitable for use in a hand holdable edible composition includes, without limitation, flavors, flavor enhancers, sweetener enhancers, and combinations thereof. Coloring agents suitable for use in a hand holdable edible composition include, but are not limited to, natural colors (e.g., caramel coloring, annatto, betanin, lycopene, beta carotene, cochineal extract, and the like), artificial dyes (e.g., FD&C Blue No. 1, FD&C Blue No. 2, FD&C Green No. 3, FD&C Red No. 3, FD&C Red No. 40, FD&C Yellow No. 5, FD&C Yellow No. 6, and the like), lakes (e.g., carmine, and the like), and other additives that impart color (e.g., dihydroxyacetone, hydrogen peroxide, and the like).

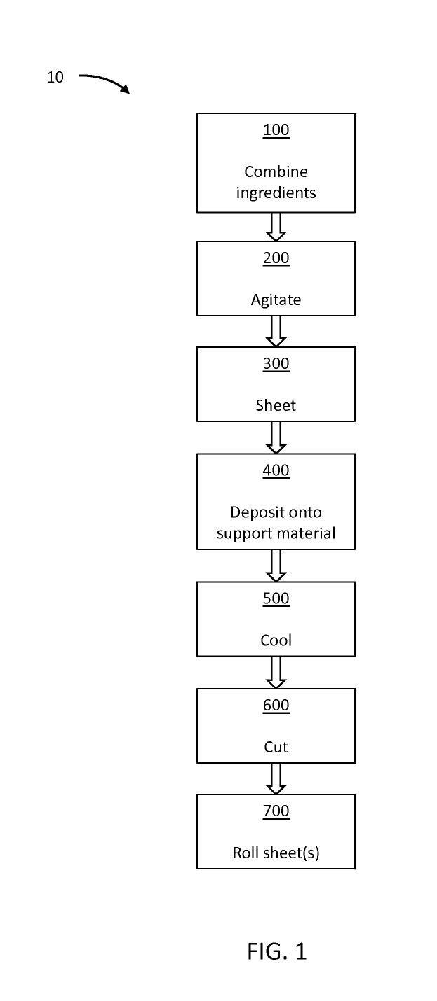

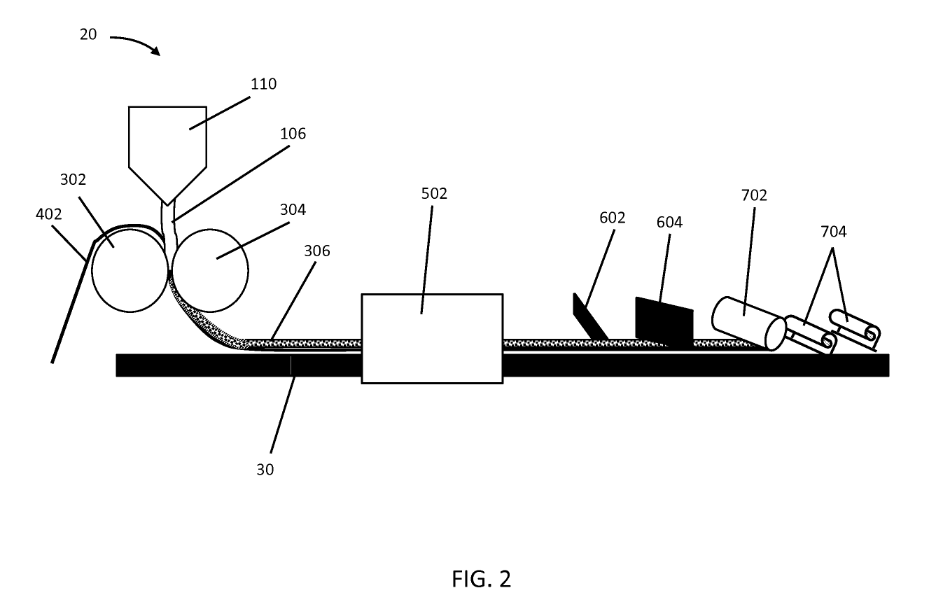

An embodiment of a method for making a hand holdable edible composition can be seen in FIG. 1, and an example of a system 20 for performing such a method can be seen in FIG. 2. In method 10, step 100 combines a dairy ingredient with a gelatin solution to produce a fluid dairy composition 106. Alternatively, gelatin can be directly dissolved in a dairy ingredient, rather than added as gelatin solution, to produce fluid dairy composition 106.

A fluid dairy composition 106 can have a temperature of from about 70° F. to about 120° F. (e.g., from about 70° F. to about 90° F., from about 75° F. to about 95° F., from about 80° F. to about 90° F., from about 80° F. to about 110° F., and the like). The temperature of a fluid dairy composition can be adjusted to reach a desired level of gelling of the gelatin in the fluid dairy composition or to result in a desired temperature of the fluid dairy composition at a later point of a method for making a hand holdable edible composition. In some embodiments, the temperature of a fluid dairy composition can be adjusted to maintain a desired level of viability of a live and active culture, if included, or to prevent degradation of one or more additional ingredients.

A fluid dairy composition 106 can also have a gelatin concentration of from about 4% to about 50% (e.g., from about 4% to about 10%, from about 4% to about 15%, from about 4% to about 25%, from about 4% to about 40%, from about 5% to about 15%, from about 5% to about 30%, from about 6% to about 20%, from about 8% to about 12%, from about 10% to about 25%, from about 15% to about 40%, from about 20% to about 50%, and the like) by weight of fluid dairy composition 106.

In some embodiments, a fluid dairy composition 106 can have a Bloom Gel Strength upon chilling of from about 200 g to about 300 g (e.g., from about 200 g to about 250 g, from about 225 g to about 260 g, from about 230 g to about 250 g, from about 240 g to about 250 g, from about 250 g to about 275 g, from about 260 g to about 300 g, and the like). Bloom Gel Strength of a fluid dairy composition can be measured by pouring the fluid dairy composition into a standard Bloom bottle to fill it approximately ¾ full and chilling for 17 hours at 10° C. to form a gel. A TA.XT Plus texture analyzer (Texture Technologies Corp., Scarsdale, N.Y.) fitted with a ½ Bloom Gelometer plunger is used to measure the force in grams required to penetrate the gel surface 4 mm at a rate of 1 mm per second. The maximum force is reported as the Bloom Gel Strength of the fluid dairy composition.

In some embodiments, a gelatin solution and/or a dairy ingredient can be pasteurized prior to combination, or a fluid dairy composition can be pasteurized after combination. The temperature of a pasteurized gelatin solution, dairy ingredient, and/or fluid dairy ingredient can be adjusted as appropriate to result in the desired temperature of the fluid dairy ingredient, or to maintain a desired level of viability of a live and active culture, if included, or to prevent degradation of one or more additional ingredients.

In some embodiments, further ingredients (e.g., a fruit and/or vegetable puree, a flavoring agent, a coloring agent, vitamins, and/or minerals, and the like) can be added at step 100 to produce a fluid dairy composition 106. In some embodiments, a live and active culture is added at step 100. If a live and active culture is added at step 100, or is already present in dairy ingredient, the temperature of fluid dairy composition 106 can be sufficient to result in the desired level of live and active culture in the finished product.

Agitation of fluid dairy composition 106 in step 200 can be used to mix fluid dairy composition 106, maintain fluid dairy composition 106 as a homogenous mixture, and/or to prevent localized gelling of the gelatin in the fluid dairy composition. Any appropriate method of agitation, such as stirring, vibration, or passing fluid dairy composition through static mixers, can be used in step 200. Fluid dairy composition 106 can be maintained at a temperature of from about 70° F. to about 120° F. during agitation.

Combining step 100 and agitation step 200 can be performed using any suitable equipment. For example, steps 100 and 200 can each take place in a tank, pipe, or hopper. In some embodiments, combining step 100 and agitation step 200 can take place simultaneously, using the same equipment. For example, ingredients can be combined and stirred in a single hopper (e.g., hopper 110 in FIG. 2). In other embodiments, ingredients can be combined and later mixed and/or agitated using the same and/or different equipment. For example, ingredients can be combined in a tank and then agitated by passing the resulting fluid dairy composition through a static mixer.

Fluid dairy composition 106 can be sheeted at step 300 by passing the fluid dairy composition 106 between first roller 302 and second roller 304. First roller 302 and second roller 304 can be spaced such that, as fluid dairy composition 106 is passed between them, the fluid dairy composition 106 forms a sheet 306 that is from about 1 mm to about 5 mm (e.g., from about 1 mm to about 2 mm, from about 1 mm to about 3 mm, from about 2 mm to about 2.5 mm, from about 2 mm to about 4 mm, from about 2.5 mm to about 4 mm, from about 2.5 mm to about 5 mm, from about 3 mm to about 4.5 mm, from about 4 mm to about 5 mm, and the like) thick. In some embodiments, sheet 306 remains fluid after passing through rollers 302, 304. In other embodiments, sheet 306 is solid after passing through rollers 302, 304.

First roller 302 and second roller 304 can each have a temperature of from about 55° F. to about 80° F. (e.g., from about 55° F. to about 75° F., from about 60° F. to about 80° F., from about 70° F. to about 75° F., from about 70° F. to about 90° F., and the like). The temperature of each roller 302, 304 can be adjusted to result in the desired viscosity of sheet 306 or to render sheet 306 solid after passing between rollers 302, 304. For example, if a solid sheet 306 is desired, the temperature of rollers 302, 304 can be lower than the melting temperature of the gelatin in fluid dairy composition 106. The temperature of each roller 302, 304 can also be adjusted to modify the level of adherence of sheet 306 to one or both of rollers 302, 304. The temperatures of rollers 302, 304 can be the same or different.

The rate of rotation of rollers 302, 304 can be adjusted to reach a desired production rate, rate of feed of fluid dairy composition 106, desired viscosity or solidity of sheet 306, and/or level of adherence of sheet 306 to one or both of rollers 302, 304. For example, if a solid sheet 306 is desired, contact of fluid dairy composition 106 to rollers 302, 304 at a temperature below the melting temperature of the gelatin in fluid dairy composition 106 can be increased by reducing the speed of rollers 302, 304.

Rollers 302, 304 can be made from any suitable material (e.g., metal or plastic). In some embodiments, rollers 302, 304 can include an anti-stick coating (e.g., nylon or Teflon (ID) to reduce adherence of sheet 306. Adherence of sheet 306 can also be reduced by including a scraper to facilitate removal of sheet 306 from one or both of rollers 302, 304.

Alternatively, fluid dairy composition 106 can be sheeted by extruding the fluid dairy composition 106 from a nozzle (not shown) to form sheet 306. An example of sheeting by extrusion can be found in U.S. Pat. No. 3,688,468.

Sheet 306 is deposited onto a support material 402 at step 400. In some embodiments, sheet 306 can be deposited on support material 402 as support material is fed between rollers 302, 304 along with sheet 306, as shown in FIG. 2. In other embodiments, sheet 306 is deposited on support material 402 after exiting rollers 302, 304 (not shown).

Suitable support material includes, for example, silicone parchment paper, cellophane, waxed paper, plastic sheeting, and the like. A support material can be chosen based on the desired strength of the support material, cost, adhesiveness to sheet 306, and the like.

In some embodiments, sheet 306 is cooled (step 500) after deposition onto a support material 402. Cooling step 500 can be achieved using any appropriate method, such as by maintaining sheet 306 at room temperature or by passing sheet 306 through a cooling tunnel (e.g., cooling tunnel 502 in FIG. 2). Sheet 306 can solidify at cooling step 500 if it has not already solidified.

Sheet 306 can be cooled to a temperature of from about 30° F. to about 60° F. (e.g., from about 30° F. to about 40° F., from about 32° F. to about 45° F., from about 35° F. to about 45° F., from about 35° F. to about 50° F., from about 40° F. to about 50° F., from about 40° F. to about 55° F., from about 40° F. to about 60° F., from about 50° F. to about 60° F., and the like). The temperature to which sheet 306 is cooled can be adjusted to reach a desired level of hardness or stickiness of sheet 306. For example, a sheet having a lower gelatin content or a gelatin with a lower Bloom Strength number can be cooled to a lower temperature as compared to a sheet having a higher gelatin content or a gelatin with a higher Bloom Strength number to reach a similar level hardness.

In some embodiments, sheet 306 is produced as a continuous sheet on support material 402. In some embodiments, sheet 306 and support material 402 are cut into a plurality of smaller sheets (step 600). Cutting of sheet 306 and support material 402 can be performed using appropriate cutters (e.g., cutters 602, 604 in FIG. 2), such as stationary or moving blades, water cutters, and the like. Cuts can be made longitudinally along the length of sheet 306 and/or transversely across sheet 306.

In some embodiments, sheet 306 can be produced at step 300 in a manner that facilitates cutting. For example, sheet 306 can include one or more gap that exposes support material for cutting so that a cutter passes through the support material 402, but not sheet 306. However, in some embodiments, a cutter can pass through both sheet 306 and support material 402.

Sheet 306 and support material 402 can be rolled into a scroll-like configuration (step 700) to produce a rolled sheet 704. Sheet 306 and support material 402 can be rolled using any suitable method. A component 702 suitable for rolling the sheet 306 and support material 402 can include, for example, a mechanical winder (e.g., as described in U.S. Pat. No. 5,723,163).

A system for performing a method for making a hand holdable edible composition can include any components appropriate for performing the method. Examples of such components include, without limitation, a conveyor (e.g., conveyor 30 in FIG. 2) to convey sheet 306 to components of the system for performing one or more step of the method, components for controlling one or more components of the system, sensors for monitoring product or components of the system, and the like.

A hand holdable edible composition can be packaged and labeled using any appropriate packaging and method. For example, a hand holdable edible composition can be packaged into packaging that provides convenience and/or portability of the hand holdable edible composition.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

“Include,” “including,” or like terms means encompassing but not limited to, that is, including and not exclusive.

The term “about” as used herein is used to indicate that the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

While the present disclosure is not so limited, an appreciation of various aspects of the disclosure will be gained through a discussion of the examples provided below.

### EXAMPLES

### Example 1

A fluid dairy composition having a 4% gelatin content was produced using a yogurt base and a pasteurized gelatin solution. The fluid dairy composition was held at a temperature of 85° F. and was sheeted onto a cellophane support material. The sheets were then passed through a cooling tunnel at 40° F. to reduce stickiness, and then were rolled into a scroll-like configuration.

A fluid dairy composition passed between a 50° F. roller set formed an inconsistent sheet with varying thickness. A fluid dairy composition passed between a 70° F. roller set produced a smooth sheet with uniform thickness. The cooled sheets could be readily rolled into a scroll-like configuration. The scroll-like rolls could be later unrolled without significant adherence to the support material.

The Bloom Gel Strength of the fluid dairy composition was from 240 g to 242 g.

### Example 2

A fluid dairy composition having a 4% gelatin content was produced with a yogurt base including 5% by weight of a strawberry puree and a gelatin solution. The fluid dairy composition was sheeted and deposited on a silicone parchment paper support material, and rolled into a scroll-like configuration. The rolled yogurt sheet could later be unrolled without significant adherence to the support material.

The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A method for making a hand holdable edible composition, comprising:
a. combining a gelatin solution with a fermented dairy ingredient to obtain a fluid dairy composition having a temperature of from about 70° F. to about 120° F. and a gelatin concentration of from about 4% to about 50% by weight of the fluid dairy composition;
b. agitating the fluid dairy composition;
c. passing the fluid dairy composition between a first roller and a second roller to form a sheeted dairy composition having a thickness of from about 1 mm to about 5 mm;
d. depositing the sheeted dairy composition onto a support material; and
e. cooling the sheeted dairy composition to obtain the hand holdable edible composition.

2. The method of claim 1, wherein the fermented dairy ingredient comprises a live and active culture.

3. The method of claim 2, wherein the hand holdable edible composition includes the live and active culture.

4. The method of claim 1, further comprising adding a live and active culture to the fluid dairy composition.

5. The method of claim 4, wherein the hand holdable edible composition includes the live and active culture.

6. The method of claim 1, wherein the first roller and second roller have a temperature of between about 45° F. and 80° F.

7. The method of claim 1, further comprising rolling the hand holdable edible composition into a scroll-like configuration.

8. The method of claim 1, wherein the hand holdable edible composition is produced as a continuous sheet.

9. The method of claim 8, further comprising cutting the continuous sheet into a plurality of smaller sheets.

10. The method of claim 1, further comprising adding a fruit or vegetable puree, a flavoring agent, or a coloring agent to the fluid dairy composition.

11. The method of claim 1, wherein the gelatin solution is pasteurized.

12. A hand holdable edible composition, comprising:
a. a dairy ingredient;
b. a live and active culture; and
c. gelatin in an amount of from about 4% to about 50% by weight of the hand holdable edible composition,
the hand holdable edible composition being formed as a sheet having a thickness of from about 1 mm to about 5 mm.

13. The hand holdable edible composition of claim 12, wherein the sheet is layered on a support material.

14. The hand holdable edible composition of claim 13, wherein the sheet and support material are rolled into a scroll-like configuration.

15. The hand holdable edible composition of claim 12, wherein the dairy ingredient is a fermented dairy ingredient.

16. The hand holdable edible composition of claim 12, further comprising a fruit or vegetable puree, a flavoring agent, or a coloring agent.

17. A hand holdable edible composition, comprising:
a. a fermented dairy ingredient; and
b. gelatin in an amount of from about 4% to about 50% by weight of the hand holdable edible composition,
the hand holdable edible composition being formed as a sheet having a thickness of from about 1 mm to about 5 mm.

18. The hand holdable edible composition of claim 17, wherein the sheet is layered on a support material.

19. The hand holdable edible composition of claim 18, wherein the sheet and support material are rolled into a scroll-like configuration.

20. The hand holdable edible composition of claim 17, further comprising a fruit or vegetable puree, a flavoring agent, or a coloring agent.
